(19) United States
(12) Patent Application Publication
(10) Pub. No.: US 2005/0274856 A1
(43) Pub. Date: Dec. 15, 2005

(54) Clamp for use with motorcycle accessories

(76) Inventor: Henry Haywood Knight II, Raleigh, NC (US)

Correspondence Address: Henry Haywood Knight, II, 4112 St. James Church Road, Raleigh, NC, 27608, US

(21) Appl. No.: 10/868,071

(22) Filed: Jun. 15, 2004

(51) Int. Cl. B62J 17/00

(52) U.S. Cl. 248/230.6

(57) ABSTRACT

A clamp having a generally C-shaped body, a pair of end portions spaced apart, and slot for receiving an accessory, or a fixture therefor, for mounting an accessory to a tubular structure. The clamp is held by a pressure fit, so that its internal surface is flush with the outer surface of the tubular structure, in fitting substantially around the tubular structure.

### FIELD OF INVENTION

This invention relates generally to clamps for securing accessories on motorcycles. More particularly, this invention relates to a C-shaped clamp that can be used to mount different types of accessories to tubular structures of motorcycles.

### BACKGROUND OF THE INVENTION

Motorcycling is continuing to grow in popularity, and the ownership of motorcycles is currently at an all time high. The motorcycle industry is driven by motorcycle owners who advocate customizing their motorcycles by adding aftermarket parts and accessories for the purpose of changing the functionality and/or appearance of the motorcycles. The “aftermarket” is comprised of a large assortment of custom parts and accessories offered by both manufacturers of stock motorcycles, and manufacturers which only fabricate motorcycle parts. This aftermarket for custom motorcycle parts and accessories is a multibillion dollar industry.

Many of the different types of motorcycle accessories can be attached to and/or detached from a motorcycle, in customizing a motorcycle. Related to the background of the present invention, a wide variety of clamps, for mounting accessories to tubular structures of motorcycles, are currently available in the market. Examples are illustrated in U.S. Pat. Nos. D-378659, and 5,988,727. Typically, these clamps include either a pair of connectable clamp sections with connecting end portions, or an O-shaped clamp with connecting end portions, which clamps must extend completely around the tubular structure of the motorcycle. Once encircling the tubular structure of the motorcycle, the end portions of the clamp are bolted together, such as by tightening a bolt, screw or allen screw to draw the end portions together, causing the clamp to tighten around and be securely retained on the tubular structure.

Thus, in using these types of clamps, the owner of the motorcycle is required to have a wrench, screwdriver, allen wrench or other tools, of the appropriate size, to attach and/or detach an accessory mounted using these clamps. One problem with this attachment/detachment method is that the necessary tools, and the appropriate size tools, may not be readily available to the owner of the motorcycle, such as when he or she is touring on the road. In addition, the desired location for mounting the accessory using a clamp may be in a location where there is minimal room for the operation of tools due to confined space within which to access and tighten the bolts or screws, which tightening is required for the clamp to be securely retained on the tubular structure.

Therefore, there is a need for a clamp to be securely retained on, and for mounting accessories to, a tubular structure of a motorcycle, wherein the clamp can be releasably attached to the tubular structure without the use of tools. Additionally, there is a need for a clamp which provides a simple and convenient means for mounting an accessory to a tubular structure of a motorcycle.

### SUMMARY OF THE INVENTION

The present invention provides a mounting clamp, for mounting an accessory to a tubular structure of a motorcycle, wherein the clamp can be releasably attached to the tubular structure without the use of tools, thereby enabling it to be attached to the tubular structure in areas of little clearance or access for tool operation.

It is another object of the present invention to provide a clamp that can be attached to a tubular structure of a motorcycle with increased ease of installation as compared to clamps of the prior art.

It is a further object of the present invention to provide a clamp, to be releasably attached to a tubular structure of a motorcycle, which is simpler in construction (single body, unitary construction) and may be less expensive to construct than clamps of the prior art.

It is another object of the present invention to provide an improved clamp for mounting an accessory to a tubular structure of a motorcycle.

These, and other objects and features are readily apparent from the following description of certain preferred embodiments of the invention taken in conjunction with the accompanying drawings.

### DESCRIPTION OF THE DRAWINGS

FIG. 1 is a top view illustrating an embodiment of a clamp of the present invention.

FIG. 2 is front elevational view of an embodiment of a clamp of the present invention.

FIG. 3 is a top plan view of an embodiment of a clamp of the present invention.

FIG. 4 is a top view illustrating another embodiment of a clamp of the present invention.

FIG. 5 is a top view illustrating another embodiment of a clamp of the present invention.

FIG. 6 is a side, elevational view of a preferred embodiment of the clamp of the present invention showing its use to mount a control cable to a fork tube.

FIG. 7 is a reverse side view of that illustrated in FIG. 6.

### DETAILED DESCRIPTION OF THE INVENTION

Definitions:

The term “tubular structure” is used herein, for purposes of the specification and claims, to mean a part of a motorcycle which is substantially tubular in shape. Tubular structures may include, but are not limited to, handle bars, the motorcycle frame, and more preferably, fork tubes, and down tubes of a motorcycle frame. As known in the art, a motorcycle is comprised of a frame generally made of tubing comprised of steel or another metal or alloy, wherein the tubing is bent and/or welded together to form the motorcycle frame. In a preferred embodiment illustrated herein, the tubular structure comprises a fork tube or a down tube, and the clamp of the present invention is used to mount a control cable to the tubular structure.

The term “control cable” is used herein, for purposes of the specification and claims, to mean a cable performing a function in control of the motorcycle. A control cable includes, but is not limited to, a throttle cable, and a brake cable.

The term “accessory” is used herein, in conjunction with mounting to a tubular structure of a motorcycle using the clamp of the present invention, and for purposes of the specification and claims, to mean a control cable, or any component part of a motorcycle that can be mounted using the clamp of the present invention. While the present invention will be illustrated using a control cable as a preferred embodiment of an accessory, it is well within the scope of the invention, as apparent to one skilled in the art from the description herein, that accessories such as motorcycle windshields or windscreens may have fixtures therefor which can be adapted with ordinary means to be used with the clamp of the present invention in mounting such accessories to a tubular structure of a motorcycle.

The clamp of the present invention is comprised of a metal which has sufficient resiliency so that the opening of the clamp may be slightly extended to be wider to allow the clamp to be fitted around the tubular structure to which it is to be affixed; yet, when released from flexing, will exert sufficient inwardly-directed pressure to come in contact with, and provide a fixed relationship on and substantially around, the tubular structure to which the clamp is releasably affixed. Preferably, the clamp is constructed of chrome, a chromed metal, or aluminum. More preferably, the clamp is comprised of billet aluminum which is polished. The substantially C-shaped body of the clamp may be formed by any process known in the art including, but not limited to, moulding, extrusion, or machining.

An object of the invention is to provide a clamp, in replacing a stock or aftermarket clamp and without modification or use of special tools, for releasably affixing to a tubular structure of appropriate size. In that regard, while there are some variations in the diameter of tubular structures, depending, for example, on the size, type, and brand of motorcycle, generally there are some preferred sizes. For example, the diameter of a fork tube on a motorcycle can vary generally from about 30 mm to about 42 mm, with a more common diameter of a fork tube being in the range of 39 mm to 41 mm. Likewise, a down tube of a motorcycle frame typically has a diameter in the range of 1 inch to 2.5 inches. However, with the ease of manufacture of the clamp of the present invention, the clamp can be customized to engage any diameter tubular member in releasably affixing the clamp to the tubular structure. Thus, the clamp may be manufactured to custom-fit a particular frame or tubular structure, or may be made to adaptably fit tubular structures having the same diameter. Therefore, the exact dimensions and construction of the tubular structure of the motorcycle are not of critical importance to the present invention, it being understood that the clamp of the present invention may be readily made to be compatible in function with a large variety of such tubular structures.

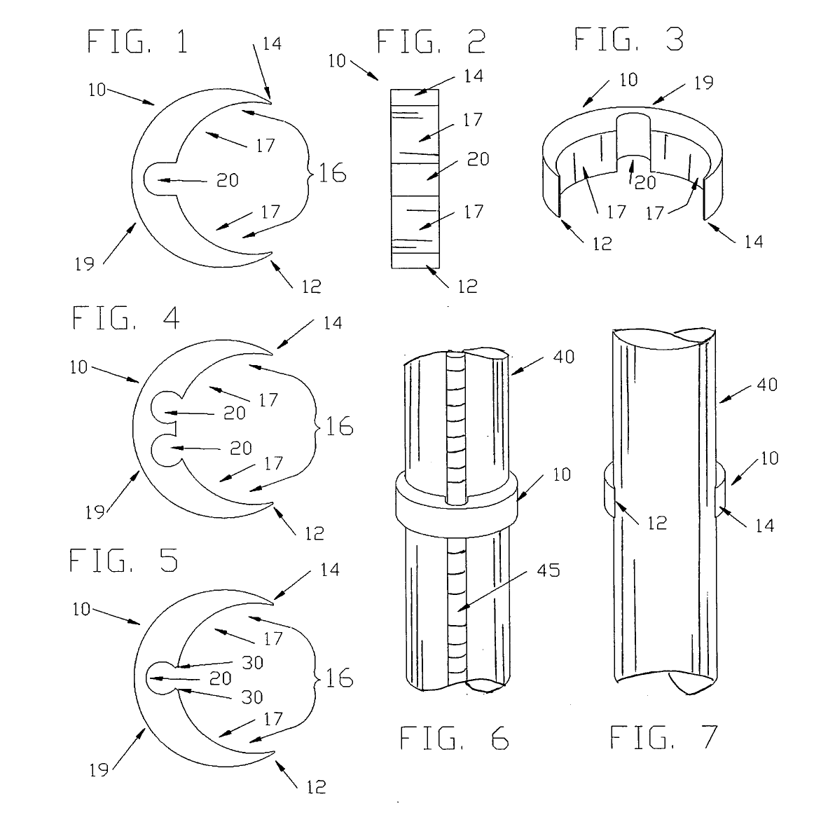

Referring to FIGS. 1-5, the clamp 10 of the present invention is made as a generally C-shaped body having an open top, bottom, and back of sufficient space to be extended substantially around, but not completely encircling a tubular structure (e.g., extends around not less than 50% and not more than 100% of the outer surface of the tubular structure in the area of attachment). Clamp 10 has end portions 12 and 14, spaced apart as opposite ends of the generally C-shaped body, which help form opening 16. Internal surface 17 of clamp 10, while being contoured in shape to conform with the generally C-shaped body of clamp 10, is substantially flat to rest adjacent to, and in flush contact with, the outer surface of the tubular structure to which clamp 10 is releasably affixed. Between outer surface 19 and internal surface 17 of clamp 10 is a slot 20, extending through the entire height (i.e., from and through the top surface to and through the bottom surface) of the body of clamp 10. Slot 20 is dimensioned to sufficiently receive an accessory for securing the accessory to a tubular structure in mounting the accessory to the tubular structure. In a preferred embodiment, the accessory comprises a control cable, and the control cable may be secured in position by being in contact with both slot 20 of clamp 10 and the outer surface of the tubular member to which it is mounted.

Referring to FIGS. 4 and 5, slot 20 may vary in number, shape and dimensions clamp 10. For example, FIG. 4 illustrates a plurality (2 or more) of slots 20 which may be used, for example, in mounting more than one control cable to a tubular structure, with each slot securing a different control cable than other slots of the plurality. Note that slots 20 of clamp 10 illustrated in FIG. 4 are more substantially a C-shape than slot 20 of clamp 10 illustrated in FIGS. 1-3 resembling more of a U-shape. The shape of slots 20 of FIG. 4 may be more desirable for forcibly inserting a control cable into a slot 20 and holding and securing the control cable solely within slot 20 and away from contacting the outer surface of the tubular member to which clamp 10 is releasably affixed, in mounting the control cable to the tubular structure. Likewise, as illustrated in FIG. 5, clamp 10 may have a slot 20 which is dimensioned with a pair of taper portions 30 which may also be used for inserting a control cable into slot 20 and holding and securing the control cable solely within slot 20 and away from contacting the outer surface of the tubular member to which clamp 10 is releasably affixed, in mounting the control cable to the tubular structure.

FIGS. 6 and 7. with FIG. 7 being a view of the reverse side illustrated in FIG. 6, illustrate the clamp of the present invention which is releasably affixed to a tubular structure of a motorcycle in mounting an accessory to the tubular structure. For ease of description, and in a preferred embodiment, FIG. 6 illustrates a tubular structure comprising a partial view of a fork tube 40 of a motorcycle; and mounted to fork tube 40 is a control cable 45 using clamp 10. To facilitate mounting the control cable to the fork tube, a control cable is inserted into a slot of the clamp. Manually, the end portions of the clamp are pulled away from each other in flexing clamp to extend slightly the width of its opening to accomodate and fit substantially around the outer surface of the fork tube. In this extended position, the clamp, with a control cable positioned in the slot of the clamp, is positioned over and substantially around the outer surface of the fork tube to which it is to be releasably affixed. The end portions of the clamp are released, thereby allowing inwardly-directed pressure of clamp to move the clamp's internal surface to come into flush contact with and in a secured pressure fit with the outer surface of the fork tube, so that the clamp extends substantially around the fork tube in releasably affixing the clamp to the fork tube, and in mounting the cable clamp in a fixed position generally parallel to the length of the fork tube. The clamp may be released and detached from the fork tube by manually pulling the clamp's end portions away from each other so that the opening of the clamp is extended sufficiently wide to release the pressure fit of the clamp to the tubular structure, and then the clamp is maneuvered away from the tubular structure.

From the foregoing, it will be obvious to those skilled in the art that various modifications in the above-described methods, and compositions can be made without departing from the spirit and scope of the invention. Accordingly, the invention may be embodied in other specific forms without departing from the spirit or essential characteristics thereof. Present embodiments and examples, therefore, are to be considered in all respects as illustrative and not restrictive, and all changes which come within the meaning and range of equivalency of the claims are therefore intended to be embraced therein.

1. A clamp for releasably affixing to a, motorcycle frame consisting essentially of:
a single generally C-shaped body to be pressure fit substantially around and encircle between 50% and 75% of the motorcycle frame;
an internal surface adapted to be in flush contact with an outer surface of the motorcycle frame;
a pair of end portions spaced apart as opposite ends of the generally C-shaped body, wherein the end portions remain spaced apart when the clamp is releasably affixed to the motorcycle frame; and
a slot extending through the entire height of the body of the clamp.

2. The clamp according to claim 1, having a plurality of slots.

3. The clamp according to claim 1, wherein the slot has a pair of tapered portions.

4. The clamp according to claim 1, wherein the slot is substantially C-shaped.

5. The clamp according to claim 1, wherein the pair of end portions provide a means for enabling the clamp to fit substantially around the motorcycle frame.

6. (canceled)

7. The clamp according to claim 1, wherein the clamp is for releasably affixing to a down tube of the motorcycle frame.

8. The clamp according to claim 1, wherein the clamp is for releasably affixing to a fork tube of a motorcycle frame.

9. A clamp for mounting an accessory to a motorcycle frame, consisting essentially of:
a single generally C-shaped body to be pressure fit substantially around and encircle between 50% and 75% of, and releasably affixed to, the motorcycle frame;
an internal surface adapted to be in flush contact with an outer surface of the motorcycle frame;
a pair of end portions spaced apart as opposite ends of the generally C-shaped body wherein the end portions remain spaced apart when the clamp is releasably affixed to the motorcycle frame; and
a slot extending through the entire height of the body of the clamp, wherein the slot is dimensioned to receive an accessory to be mounted or a fixture therefor.

10. The clamp according to claim 9, having a plurality of slots.

11. The clamp according to claim 9, wherein the slot has a pair of tapered portions.

12. The clamp according to claim 9, wherein the slot is substantially C-shaped.

13. The clamp according to claim 9, wherein the pair of end portions provide a means for enabling the clamp to fit substantially around but not completely encircling the motorcycle frame.

14. (canceled)

15. The clamp according to claim 14, wherein the clamp is for releasably affixing to a down tube of the motorcycle frame.

16. The clamp according to claim 9, wherein the clamp is for releasably affixing to a fork tube of a motorcycle frame.

17. The clamp according to claim 9, wherein the slot is dimensioned to receive an accessory comprising a control cable.

18. The clamp according to claim 17, wherein the clamp is releasably affixed to a down tube or a fork tube of a motorcycle frame.
